(19) United States
(12) Patent Application Publication
(10) Pub. No.: US 2026/0228782 A1
(43) Pub. Date: Aug. 6, 2026

(54) PERSONALIZED DISPLAY OF CUSTOMER ELIGIBLE OFFER STORIES

(71) Applicant: Target Brands, Inc., Minneapolis, MN (US)

(72) Inventors: Janet Keel, St. Paul, MN (US); Maggie Smith, Minneapolis, MN (US); Princewill Eneh, Eden Prairie, MN (US); Fan Zhang, Pittsburgh, PA (US); Kusumakumari Vanteru, Sunnyvale, CA (US); Yujin Lee, Rochester, MI (US); Siyu Qi, Minneapolis, MN (US); Chad Morgan, Sunnyvale, CA (US); Marcus LaBrecque, Boston, MA (US); Ken Dombeck, Eden Prairie, MN (US)

(73) Assignee: Target Brands, Inc., Minneapolis, MN (US)

(21) Appl. No.: 19/531,257

(22) Filed: Feb. 5, 2026

Related U.S. Application Data
(60) Provisional application No. 63/755,056, filed on Feb. 6, 2025.

(51) Int. Cl. G06Q 30/0241

(52) U.S. Cl. CPC G06Q 30/0276

(57) ABSTRACT

A system and method for efficiently serving personalized offer content across digital platforms through a unified content architecture are provided. The system includes a data repository storing single-instance content elements and a server system that dynamically serves offer stories while performing real-time eligibility verification. The server system maintains a unified content pool, enabling automatic adaptation of content across different channels while reducing computational resource usage through consolidated storage. The system performs real-time eligibility checks through integration with loyalty services, dynamically collapses offer slots when users are ineligible, and automatically updates offer visibility based on eligibility changes. The system enables querying and serving of content while supporting real-time updates to display manner as user behavior and eligibility changes.

### CROSS-REFERENCE TO RELATED APPLICATIONS

The present application claims priority to U.S. Provisional Ser. No. 63/755,056, filed on Feb. 6, 2025, the disclosure of which is hereby incorporated by reference in its entirety.

### BACKGROUND

Online retail environments traditionally present promotional content, including deals and offers, across different channels like mobile applications, websites, and desktop interfaces. Historically, content had to be specifically adapted and curated for each channel, requiring manual modification to meet the presentation requirements of each platform.

Additionally, promotional offers are typically shown uniformly to all users or restricted to specific pages, limiting the ability to personalize and present offers to relevant users. This traditional approach also faces technical limitations in efficiently storing and serving promotional content across platforms, often requiring multiple instances of the same content to be maintained for different channels. This results in increased computational resource usage and complexity in content management.

Still further, a user's eligibility to receive a particular offer may change over time, and may be independent of other users'eligibility. For example, if one user has already redeemed a particular offer but the offer remains open for others, that redeeming user may be presented the same offer after they had redeemed it, thereby presenting them with irrelevant or non-engaging content.

### SUMMARY

In general terms, the present disclosure relates to methods of serving eligible offers tailored to a limited subset of customers throughout a digital platform in a prioritized and dynamic manner. Prioritizing and dynamically placing eligible offers in a prominent way, or in the right context, enables a streamlined user interface and efficient, contextualized placement of offers.

In a first aspect, a webserver system is designed for dynamically serving offer stories. The system comprises a data repository that is configured to store a plurality of offer stories. It also includes a server system that is in data communication with the data repository and a plurality of client computing devices. The server system is configured to receive requests for web content from the plurality of client computing devices. A subset of these client computing devices are associated with user credentials. The server system assigns an eligibility score to the client computing devices associated with user credentials. Based on the eligibility score, the server retrieves a subset of offer stories from the data repository. The server then scores the subset of offer stories based on one or more predetermined variables to obtain one or more preferred offer stories. Finally, the server serves the one or more preferred offer stories to the client computing devices associated with user credentials. These preferred offer stories are displayed within a container in the web content designated for the display of offer stories.

In a second aspect, a method of dynamically serving offer stories comprises several steps. The method involves receiving a request for web content from a client computing device, wherein the client computing device is associated with user credentials, and retrieving a plurality of offer stories from an offer story repository. The method also includes scoring the plurality of offer stories based on one or more predetermined variables to generate a ranked list of offer stories and assigning an eligibility score to the client computing device based on user eligibility data associated with the user credentials. The method further includes determining, at serve time and based on the eligibility score, a subset of eligible offer stories from the ranked list of offer stories, and selecting a highest-ranked offer story from the subset of eligible offer stories. The method also includes serving the highest-ranked offer story to the client computing device within a container of the web content designated for display of offer stories.

In a third aspect, a webserver system is designed for dynamically serving offer stories. The system comprises a data repository configured to store a plurality of offer stories. It also includes a server system that is in data communication with the data repository and a plurality of client computing devices. The server system is configured to receive requests for web content from the plurality of client computing devices. A subset of the client computing devices are associated with user credentials. The server system identifies a subset of category offers at a webpage context classification engine. It assigns a client eligibility score to the client computing devices associated with user credentials. Based on the client eligibility score, the server retrieves a subset of offer stories from the data repository. It then scores the subset of offer stories based on one or more predetermined variables to obtain one or more preferred offer stories. The server serves the one or more preferred offer stories to the client computing devices associated with user credentials. These preferred offer stories are displayed within a container in the web content designated for the display of offer stories.

In a fourth aspect, the disclosure provides a system for managing promotional content across multiple delivery channels. The system comprises a unified content repository storing single-instance promotional content elements comprising configurable visual components including images, headlines, and links. A server system in data communication with the unified content repository is configured to receive requests for promotional content from a plurality of delivery channels including web interfaces, mobile applications, and push notification services. The server system automatically adapts presentation format of the promotional content elements based on channel-specific requirements associated with each delivery channel.

### BRIEF DESCRIPTION OF THE DRAWINGS

FIG. 1 illustrates an example webserver environment in which aspects of the present disclosure may be implemented;

FIG. 2 is a block diagram of an example architecture of aspects of a content server system usable within a retail enterprise.

FIG. 3 is a block diagram of an example architecture of aspects of a content server system usable within a retail enterprise.

FIG. 4 is a flowchart of an example method performable by a content server system.

FIG. 5 is a flowchart of an example method performable by a content server system.

FIG. 6 is a flowchart of an example method of serving contextualized offer stories, according to an example embodiment.

FIG. 7 illustrates a user interface, according to an example embodiment.

FIG. 8 illustrates a user interface, according to an example embodiment.

FIG. 9 illustrates a user interface, according to an example embodiment.

FIG. 10 illustrates a user interface, according to an example embodiment.

FIG. 11 illustrates a user interface, according to an example embodiment.

FIG. 12 illustrates a user interface displaying a push notification, according to an example embodiment.

FIG. 13 is a block diagram of an example computing system with which aspects of the present disclosure may be implemented.

### DETAILED DESCRIPTION

As briefly described above, embodiments of the present invention are directed to methods of serving eligible offers tailored to a limited subset of customers throughout a digital platform in a prioritized and dynamic manner.

In example implementations, a dynamic content delivery system is provided that enables personalized content (e.g., segmented offers) to be prominently displayed anywhere on the platform while ensuring only eligible users see them. Such a system includes a number of features that improve the timing of delivery of relevant content through, e.g., real-time eligibility checks through integration with loyalty services associated with an online retailer, as well as dynamic display elements that are configured to collapse user interface elements that contain offer slots when a particular user is determined to be ineligible to receive the content/offer. The system manages dynamic user eligibility and adjusts visibility based on changes to user eligibility.

Additionally, in some instances, the dynamic content delivery system provides a unified content pool in which content elements are stored in a single repository and may be drawn from that repository for use across a plurality of different delivery channels (e.g., web, mobile application, email, etc.). Content presentation is automatically adapted to the user display in accordance with the particular channel. The consolidated storage for use cases across different delivery channels reduces computational resources. By maintaining single-instance storage of promotional content usable across multiple channels, the system reduces computational resources and storage requirements compared to systems that maintain separate content instances for each delivery channel while ensuring consistent promotional messaging across all customer touchpoints

Furthermore, the dynamic content delivery system provides enhanced personalization capabilities, which allow mapping of particular offers to products in an n-dimensional space, while comparing offers against individualized user interests and behavior, enabling selection of relevant offers for each user, and support for real-time updates to the display manner of various offers as user behavior changes. Overall, this provides reduced computational resource usage through unified content storage, improved consistency across content delivery channels, real-time eligibility assessment and verification, alongside dynamic content adaptation for different user eligibility and across different delivery channels.

As used herein, an “offer story” refers to a structured promotional content object stored in a data repository and configured for dynamic selection, eligibility evaluation, and presentation to a user. An offer story comprises offer data defining promotional terms, associated eligibility criteria, and presentation data defining visual or interactive elements, and is adaptable for display across one or more delivery channels and user interface containers.

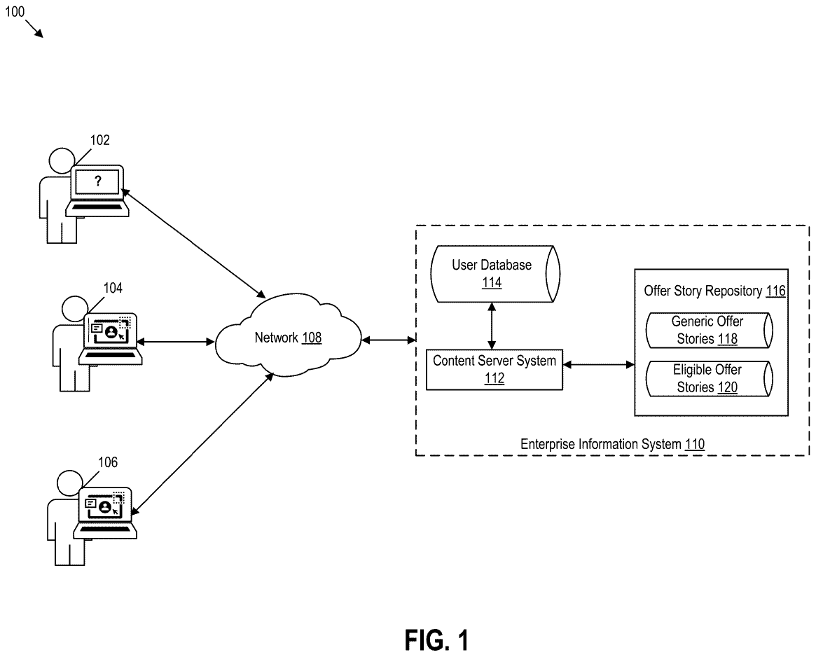

Referring to FIG. 1, an example webserver environment 100 is shown in which aspects of the present disclosure may be implemented. In some embodiments, the webserver environment 100 is a webserver system for dynamically serving offer stories. The environment includes a content server system 112 that hosts a user database 114, and communicates with an offer story repository 116. The content server system may be part of an enterprise information system 110 that is accessible via network 108 by a variety of users 102, 104, 106 using various types of computing devices. In some embodiments, a loyalty service can also be part of the enterprise information system 110. For example, the loyalty service can host real-time eligibility data for one or more segmented offer stories. In some examples, real-time eligibility data can be based on an enterprise marketing budget limiting the number of enterprise-funded offers that can be redeemed.

The offer story repository 116 is a data repository configured to store a plurality of offer stories.

The user database 114 is configured to store user credentials and eligibility information for users accessing the system. The offer story repository 116 maintains two types of offer stories: generic offer stories 118 that are available to all users, and user eligible offer stories 120 that are restricted to specific eligible users.

The server system 112 operates within the enterprise information system 110 to manage and serve offer stories to users. In some implementations, the server system 112 is in data communication with one or more data repositories and a plurality of client computing devices. For example, the server system 112 can be in data communication with the offer story repository 116 and the user database 114. The server system 112 is configured to receive requests for web content from a plurality of client computing devices. In some embodiments, a subset of the plurality of client computing devices are associated with user credentials. In some implementations, the server system 112 can assign client eligibility scores to devices associated with user credentials. In some further implementations, the server system 112 can retrieve eligible offer stories from the repository based on client eligibility scores. In other implementations, the server system 112 can retrieve, based on the eligibility score, a subset of offer stories from offer story the data repository. For example, users 104 and 106 may be associated with user credentials such that client eligibility scores can be assigned to their respective computing devices. In another example, user 102 is not be associated with user credentials. Therefore, the computing device associated with user 102 will not receive eligible offer stories.

The server system 112 further is configured to, in some cases, score and serve preferred offer stories to eligible users. For example, the server system 112 can be configured to score a subset of offer stories based on one or more predetermined variables to obtain one or more preferred offer story. In other embodiments, the server system 112 can be configured to identify a subset of category offers at a webpage context classification engine. In some implementations, category offers can also be referred to as segmented offers. The system implements a unified content pool architecture that enables storage of single-instance content elements usable across multiple channels, automatic adaptation of content presentation based on channel requirements, as well as efficient querying and serving of content. In some embodiments, the server system 112 can serve one or more preferred offer stories to client computing devices associated with user credentials. For example, the server system 112 can serve one or more preferred offer stories within a container within the web content displayed on a user interface designated for display of offer stores.

The server system 112 performs real-time eligibility verification through integration with user eligibility data service 220 for immediate status updates during page load operations. Eligibility status is verified at serve time rather than being pre-computed, ensuring accuracy when redemption limits, expiration times, or user eligibility status changes between page loads or during browsing sessions.

The system provides dynamic collapsing of offer slots when users are determined to be ineligible for all available offers configured for a particular slot. In some example implementations, the selection or display of one or more preferred offer stories is dynamically adjusted in real-time in response to changes in eligibility detected by the user eligibility data service 220 or user interactions with one or more preferred offer stories. The server system 112 further provides real-time updates to offer visibility as user eligibility changes during a session, as well as automatic replacement of expired or redeemed offers with the next-highest ranked eligible offer, as illustrated below.

The network 108 can include any combination of local area networks (LANs), wide area networks (WANs), and the Internet, enabling communication between the various system components using standard networking protocols.

The enterprise information system 110 provides backend services and data management capabilities that support the content server system's ability to maintain user eligibility data, process offer redemptions, track offer performance, and manage offer lifecycle states.

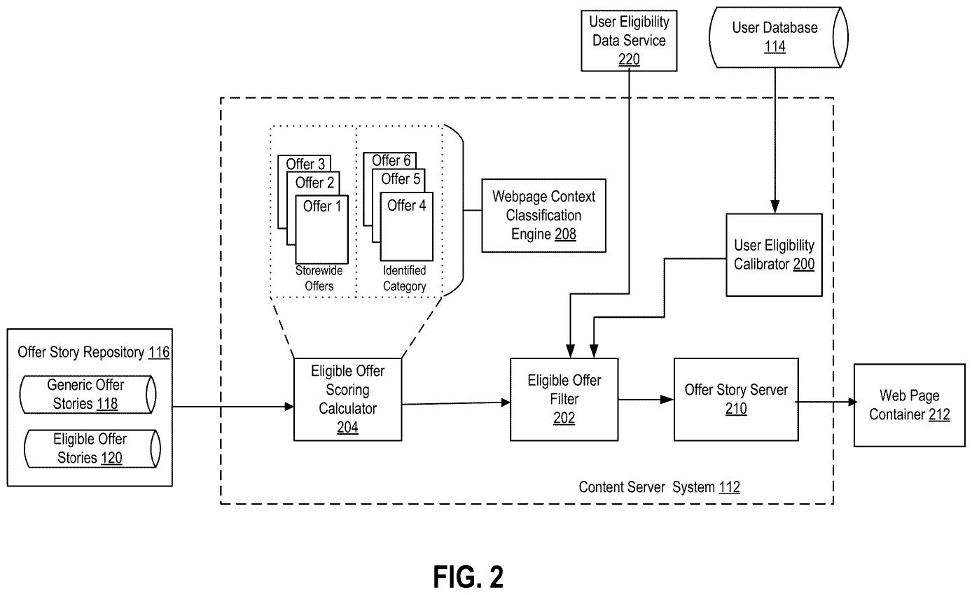

Referring to FIG. 2, a block diagram illustrates the content server system 112 and its interaction with the user database 114 and offer story repository 116 to serve eligible offers to a web page container 212. The content server system 112 implements an architecture for managing and serving personalized offer content. As illustrated in FIG. 2, the content server system 112 includes a user eligibility calibrator 200, eligible offer filter 202, eligible offer scoring calculator 204, webpage context classifier 208, and offer story server 210.

Offer story data repository 116 is configured to store a plurality of offer stories. In some embodiments, offer story data repository 116 can include generic offer story data 118 and eligible offer story data 120. In some examples, offer story data can indicate whether an offer story is a storewide offer or a specific category associated with the offer story. In some embodiments, offer story data can also include an offer redemption limit status. For example, a redemption limit status may correspond to a specific marketing budget limiting the number of offers that can be redeemed. For example, a marketing budget can be a retail enterprise budget associated with enterprise-funded offers or a vendor budget for vendor-funded offers. In some examples, a redemption limit can be associated with a single user. In other examples, a redemption limit can be associated with a plurality of users or a total number of users. In some embodiments, offer story data can include an offer expiration status indicating whether the offer story is expired.

In some examples, eligible offer story data 120 includes promotional content restricted to users meeting specific eligibility criteria. In some embodiments, eligible offers can include segmented promotional offers targeted to particular user segments, gamified rewards where users complete challenges for benefits, partner benefits from third-party collaborations, loyalty program bonuses for achieving membership tiers, and other eligibility-restricted promotional content.

In some example embodiments, user eligibility calibrator 200 may be used, with user data from user database 114, to determine user eligibility. In alternatives, a user eligibility data service 220 may be used to obtain user eligibility information. In some embodiments, user eligibility data service 220 is an external service operated independently from content server system 112, such as a loyalty service system that maintains real-time eligibility data for users across an enterprise.

In embodiments, the content server system 112 may stage eligibility data, for example from a user database 114, in a local data repository (such as a Cassandra database) for subsequent retrieval during serve time. This staged implementation allows the content server system 112 to query locally-stored eligibility data rather than making real-time external service calls. Both the real-time API call embodiment and the staged data embodiment enable the system to verify user eligibility before serving eligible offer stories.

In the example shown, eligible offer scoring calculator 204 receives offer story data from the offer story repository 116. In some embodiments, the eligible offer scoring calculator 204 receives all available offer stories, including both generic offer stories 118 and eligible offer stories 120, and scores them based on offer characteristics and user preferences before eligibility filtering occurs. The eligible offer scoring calculator 204 also receives offer metadata from a promotional system including offer type classification (storewide offers vs. category-specific offers), eligible items, discount values, redemption constraints, and offer expiration information. This metadata is used during the scoring process to prioritize offers based on offer type and user relevance.

Eligible offer scoring calculator 204 receives offer stories from the offer story repository 116 and scores them based on one or more predetermined variables to obtain a ranked list of offer stories. The scoring occurs before eligibility filtering, allowing the system to rank all available offers and then filter to only those offers for which the user is eligible at serve time. One or more predetermined variables can include user preferences, offer context, offer value, or offer exclusivity. User preferences can include user category preferences, product preferences, brand preferences, or prior offer redemption history. Offer context can include whether an offer is a storewide offer or a category-specific offer. In some implementations, storewide offers are ranked higher than category-specific offers due to being more engaging and broadly applicable to users.

In some embodiments, the eligible offer scoring calculator 204 implements a multi-tiered scoring approach. For storewide offers that can be applied to any purchase across the platform, the system assigns higher base scores to prioritize these more flexible offers. For category-specific offers restricted to particular product categories, the system employs personalized ranking algorithms. In one embodiment, the system uses a collaborative filtering approach that represents both offers and user purchase history in an embedding space and calculates cosine similarity scores between user behavior vectors and offer characteristic vectors. In another embodiment, the system employs a gradient boosting machine learning model trained on user purchase behavior, click data, and product page view data to predict the likelihood of user engagement with specific offers. The eligible offer scoring calculator 204 outputs the scored and ranked list of offer stories to the eligible offer filter 202 for eligibility verification at serve time.

In examples, eligible offer filter 202 may be configured to filter eligible offers identified by the eligible offer scoring calculator 204. In some implementations, offer story filter 202 can allow a subset of eligible offer stories to be presented to a user based on a user eligibility score received from the user eligibility calculator 200. For example, the eligible offer filter 202 can determine a filtered list of one or more eligible offer stories, once scored, that can be presented to a user. In other examples, the eligible offer filter 202 can generate a filtered list of eligible offer stories based on user eligibility data combined with offer story data. For example, the eligible offer filter 202 can generate a filtered list of eligible offer stories based on one or more of: an offer expiration status, an offer allocation status, an offer added status, or offer redemption criterion. In some examples, offer redemption criterion can include an offer redeemed status, or offer redemption limit status.

For example, if an offer expiration status indicates that an offer story is expired, then it may not be included in the filtered list generated by the eligible offer filter 202. In other examples, if an offer expiration status indicates that an offer story is not expired, then it may be included in the filtered list.

In some examples, if an offer redemption limit status indicates that a redemption limit associated with an offer has been reached, then the offer may not be included in the filtered list. In other examples, if an offer redemption limit status indicates that a redemption limit associated with an offer has not been reached, then the offer may be included in the filtered list.

In some examples, if an offer added status indicates that an offer has been added by a user, then the offer may not be included in the filtered list. In one filter scenario, if an offer expiration status indicates that an offer story is not expired, while an offer added status indicates that an offer has been added by a user, then the offer may not be included in the filtered list generated by the eligible offer filter 202. This filter scenario allows for a streamlined user interface that avoids duplicating offers that the user has already seen and added to their cart or offer library.

In some examples, if an offer redeemed status indicates that the offer has been redeemed by a user, then the offer may not be included in the filtered list. In other examples, even if an offer redeemed status indicated that the offer has been redeemed by the user, it may still be included in the filtered list. For example, in one filter scenario, even if a user has already redeemed an eligible offer, if the redemption limit for the eligible offer has not been reached then the eligible offer can be presented to the user again. Advantageously, this further enhances the impact and personalization of eligible offer stories by allowing the most relevant, useful offers to be presented to a user more than once.

In some implementations, the eligible offer scoring calculator 204 includes a webpage context classifier 208. Webpage context classifier 208 is configured to identify and filter category-specific eligible offer stories based on an identified webpage context provided by site merchandising configurations. Site merchandisers define category filter criteria for each offer container slot within page templates. For example, a merchandiser may configure a home category page to display only home-related offers, or may configure cross-promotional display by allowing grocery offers to appear on the homepage to drive traffic to the grocery category. The webpage context classifier 208 receives the filter criteria defined for each slot and applies those criteria to identify the subset of offers eligible for display in that context.

After contextual filtering, the system ranks the context-appropriate offers based on user behavior and preferences. For example, if a user browses a home furnishings category page with an offer container configured to display home-related offers, the webpage context classifier 208 identifies offer stories tagged for home categories and provides them to the scoring process. The eligible offer scoring calculator 204 then ranks these home category offers based on the user's historical engagement with home products, purchase patterns in home categories, and the offer characteristics (storewide vs. category-specific, discount value, etc.).

In some implementations, storewide offers receive priority ranking even within contextually filtered results because they provide maximum flexibility to users. In other implementations, site merchandisers can configure the system to prioritize contextually relevant category-specific offers over storewide offers to emphasize targeted promotions aligned with the user's current browsing context.

In some embodiments, the eligible offer filter 202 can present allocation data to the offer story repository 116 indicating that one or more eligible offers has been allocated to a user. Allocation status prevents over-allocation of budget-constrained offers by reserving offers for specific users before redemption occurs, ensuring that users who are shown an offer can complete the redemption process even if other users are simultaneously redeeming the same offer. In some implementations, an allocation status can be assigned to one or more offer stories included in the filtered list of offer stories. The use of an allocation status can increase -efficiency and accuracy in other downstream calculations or filtering. For example, storing and presenting allocation data to the eligible offer filter can improve efficiency by reducing the number of calculations required to present eligible offer stories to the user in future scenarios. In other examples, storing and presenting allocation data can further increase efficiency and accuracy in limiting the number of users that a budget constricted eligible offer is presented to. For example, this can prevent significant user frustration due to an eligible offer being overallocated and disappearing if the user refreshes their user interface due to reaching its redemption limits being reached between page views. In some implementations, allocations expire after a predetermined time period (such as 24 hours) or when the user's browsing session ends, returning unredeemed allocated offers to the available pool.

In example implementations, the allocation status increases system efficiency by reducing repeated eligibility calculations for the same user-offer pair during a browsing session. Once an offer is allocated to a user, subsequent page loads can reference the allocation status rather than re-performing the complete eligibility verification process, reducing computational overhead and improving response time. Additionally, storing and tracking allocation data prevents user frustration that would occur if an eligible offer disappeared when a user refreshed their interface due to redemption limits being reached between page views. In some implementations, allocations expire after a predetermined time period (such as 24 hours) or when the user's browsing session ends, returning unredeemed allocated offers to the available pool.

In some embodiments, a user eligibility score, obtained from either the user eligibility data service 220 or user eligibility calculator 200, can indicate that an eligible user is eligible to receive eligible offer stories based on specific eligibility criteria. In some implementations, a user eligibility score can include an offer redeemed status indicating that a user has already redeemed one or more eligible or generic offer stories. In some examples, a user eligibility score can include an offer added status indicating that a user has added one or more eligible or generic offer stories to a user's shopping cart or to an offer library. In still other implementations, the user eligibility score can further indicate a loyalty status associated with a user or a user appreciation status (such as a user's birthday, veteran status, or verified occupation such as teacher status).

In some implementations, assigning an eligibility score includes retrieving, from user eligibility data service 220, real-time eligibility data for one or more eligible offer stories at the time of page request, typically completing eligibility verification within 50-200 milliseconds. This real-time verification ensures accuracy when redemption limits, expiration times, or user eligibility status changes between page loads. The user eligibility calibrator 200 outputs eligibility data to the eligible offer filter 202.

In embodiments where user data is staged, a user eligibility calibrator 200 is configured to output a user eligibility score that indicates whether a user is eligible to receive one or more eligible offers. The user eligibility calibrator 200 can output a user eligibility score. In some examples, a user eligibility score can indicate whether a user is an eligible user or an ineligible user. For example, if the eligible offer filter 202 receives data indicating that a user is not associated with a sign-in status or user credentials, then the user eligibility calibrator 200 can assign a score indicating that the user is an ineligible user. In other examples, if the user eligibility calibrator 200 receives user data indicating that a user is associated with a sign-in status or user credentials, then the user eligibility calibrator 200 can assign a score indicating that the user is an eligible user.

In other examples in which eligibility is assessed locally, if the user eligibility calibrator 200 receives user data indicating that a user is not associated with a sign-in status or user credentials, then the user eligibility calibrator 200 can assign a score indicating that the user is an ineligible user. In other examples, if the user eligibility calibrator 200 receives user data indicating that a user is associated with a sign-in status or user credentials, then the user eligibility calibrator 200 can assign a score indicating that the user is an eligible user. In some embodiments, the user eligibility score can indicate that an eligible user is eligible to receive a subset of eligible offer stories. In other embodiments, the user eligibility score can indicate that an eligible user is eligible to receive all eligible offer stories. In some implementations, a user eligibility score can include an offer redeemed status. For example, an offer redemption status can indicate that a user has already redeemed one or more eligible or generic offer stories. In some examples, a user eligibility score can include an offer added status. For example, an offer added status can indicate that a user has added one or more eligible or generic offer stories to a user's shopping cart or to an offer library stored at the user's device that may be used for future purchases. For example, a user's shopping cart can be associated with a purchase that is not yet completed. In other implementations, the user eligibility score can further indicate a loyalty status associated with a user. In still other implementations, the user eligibility score can indicate a user appreciation status. For example, a user appreciation status can indicate a user's birthday, a user's veteran status, or a user's occupation. In some implementations a user's occupation can be a verified occupation. In some examples, a user's occupation can include their status as a teacher. The user eligibility calculator can output a user eligibility score to the eligible offer filter 202. In some examples, some or all of the assessments performed at the user eligibility calibrator 200 may be provided by the user eligibility data service 220.

In some embodiments, the user eligibility calibrator 200 can output a device eligibility score. For example, if the user eligibility calibrator 200 receives data indicating that the user device is not associated with a sign-in status or user credentials, then the user eligibility calibrator 200 can output a score indicating that the device is an ineligible device. An example of an ineligible device is illustrated with respect to the user device associated with user 102 as shown in FIG. 1. In other examples, an eligible device status can be output from the user eligibility calibrator 200 upon receiving data indicating that the user device is associated with a sign-in status or user credentials. Examples of eligible devices are illustrated with respect to the user devices associated with users 104 and 106 as shown in FIG. 1. In some implementations, assigning an eligibility score to a user device includes retrieving, from a loyalty service, real-time eligibility data for one or more eligible offer stories.

Offer story server 210 receives eligible offers from the eligible offer scoring calculator 204. In some embodiments, offer story server 210 receives a scored or ranked list of eligible offer stories from the scoring calculator 204. In other embodiments, offer story server 210 receivers a highest scored eligible offer story. Offer story server 210 is configured to serve eligible offer stories to a web page container 212 at a user interface of a client computing device associated with user credentials. In some implementations, offer story server 210 is configured to serve the highest scored offer story to a container within web content designated to display eligible offer stories.

Web page container 212 can receive one or more offer stories from offer story server 210. Web page container 212 can be a container within web content designated for the display of offer stories. For example, web page container 212 can be configured to display one or more eligible offer stories at the user interface associated with an eligible user or eligible user device. In some embodiments, web page container 212 can be further configured to be dynamically adjusted in response to a change in user eligibility or user interaction with the one or more eligible offer stories.

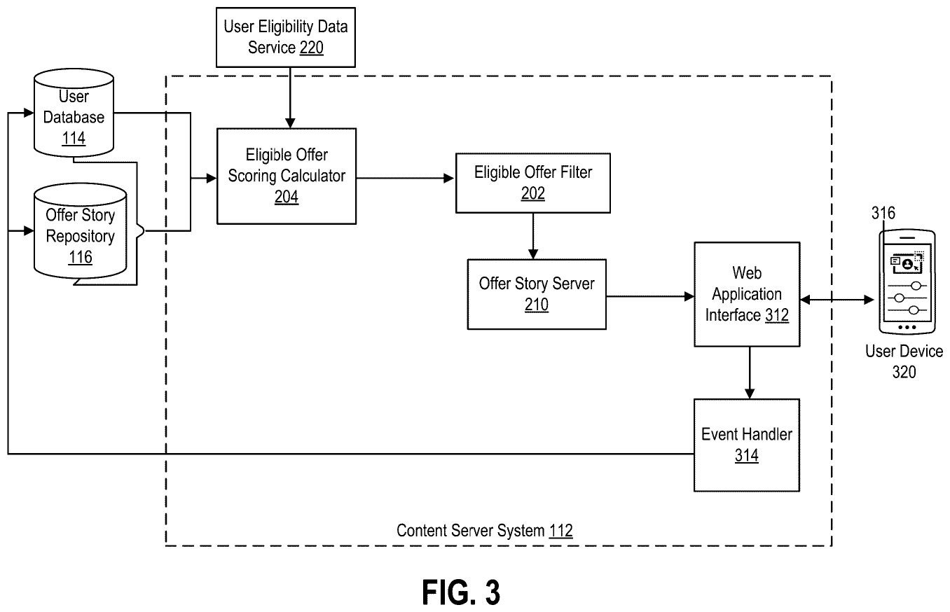

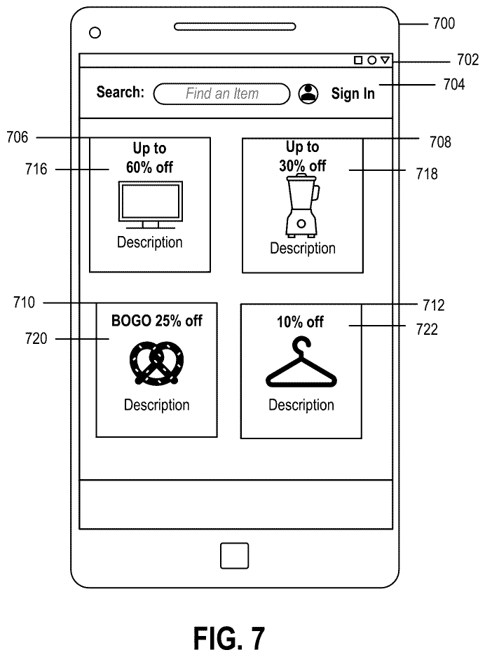

Referring to FIG. 3, a block diagram is another illustration of an example content server system 112 and its interaction with the user database 114 and offer story repository 116 to serve eligible offers to a user device 320. As discussed with respect to FIG. 2, the content server system 112 includes an eligible offer filter 202, eligible offer scoring calculator 204, and eligible offer story server 210. In the example illustrated in FIG. 3, the content server system further includes a web application interface 312 and an event handler 314. The example of FIG. 3 further includes a user interface 316 of the user device 320. Examples of user devices and user interfaces will be illustrated and described with reference to FIGS. 7-11.

Web application interface 312 may receive eligible offer stories from the offer story server 210. In some embodiments, the web application interface 312 can also receive generic offer stories from the offer story server. In some embodiments, the web application interface 312 may be configured to communicate with the user interface 316 of the user device 320. In some embodiments, the web application interface 312 may be configured to communicate with a plurality of user devices 320 (e.g. the user devices associated with users 102-106 of FIG. 1). Furthermore, the web application interface 312 may be configured to receive data from the user interface 316. For example, the web application interface 312 may receive updates or events from the user interface 316 that correspond to user interaction with one or more offer stories. In some embodiments, the web application interface may output data received from the user interface 316 to the event handler 314.

Event handler 314 may receive data from the user interface 316 via the web application interface 312. Based on the received data, the event handler 314 may receive updated user data that is automatically generated by user interaction with the user interface 316. For example, updated data may include an offer being added, removed, or redeemed by the user. In some examples, updated data may include a device sign-in status or a change in user credentials. In some embodiments, the event handler 314 may further output updated data to the user database 114 or offer story repository 116. In this manner, updated data can be used to further refine offer ranking to enhance personalization and contextualization of offer stories in an efficient and automated manner. Furthermore, updated data can be used to streamline a user experience by automatically collapsing or replacing offer stories in response to feedback received at the user interface. Examples of these advantages will be illustrated and described in reference to FIGS. 7-11. Still further, updated data can be used to evaluate offer performance to further improve development, placement, and personalization of future offer stories.

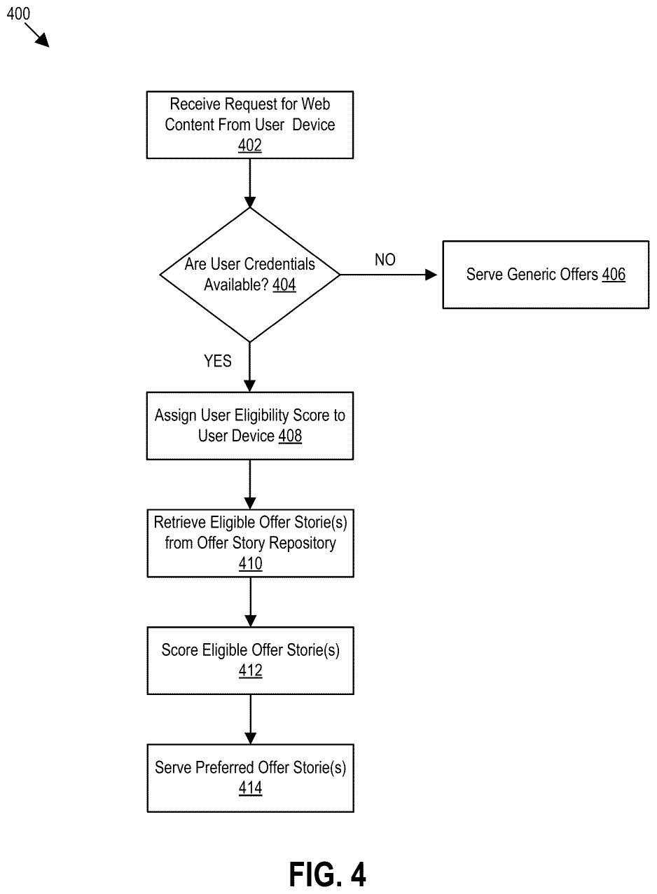

FIG. 4 is a flowchart of an example method 400. In some embodiments, operations of the method 400 may be performed by components of the content server system 112.

In the example shown, the content server system 112 may receive a request for web content from a user device (step 402). For example, the content server system 112 may receive a request for web content by a user via a user interface. The request for web content may include a plurality of offer containers. In some examples, the plurality of offer containers may include offer containers on a home page. In other examples, the plurality of offer containers may include offer containers on a category page. In still other examples, the plurality of offer containers may include offer containers on an item page.

In the example shown, the content server system 112 may determine whether user credentials are available (step 404). For example, the content server system 112 may determine whether user credentials are available by determining a login status associated with the user device. In other examples, the content server system 112 may determine whether user credentials are associated with the user device.

In the example shown the content server system 112 may assign a user eligibility score (step 408). For example, the content server system 112 may assign a user eligibility score to the user device. An example of assigning a user eligibility score is described above in connection with the user eligibility calibrator 200 in FIG. 2

In the example shown, the content server system 112 may retrieve eligible offer stories from the offer story repository (step 410). In some embodiments, the content server system 112 may retrieve a filtered subset of offer stories. An example of an eligible offer filter 202 is described above in connection with FIG. 2.

In the example shown, the content server system 112 may score the eligible offer stories retrieved from the offer story repository (step 412). An example of scoring eligible offer stories is described above in connection with the offer scoring calculator 204 in FIG. 2.

In the example shown, the content server system 112 may serve one or more preferred offer stories to the user device (step 414). An example of serving one or more preferred offer stories is described above in connection with offer story server 210 in FIG. 2.

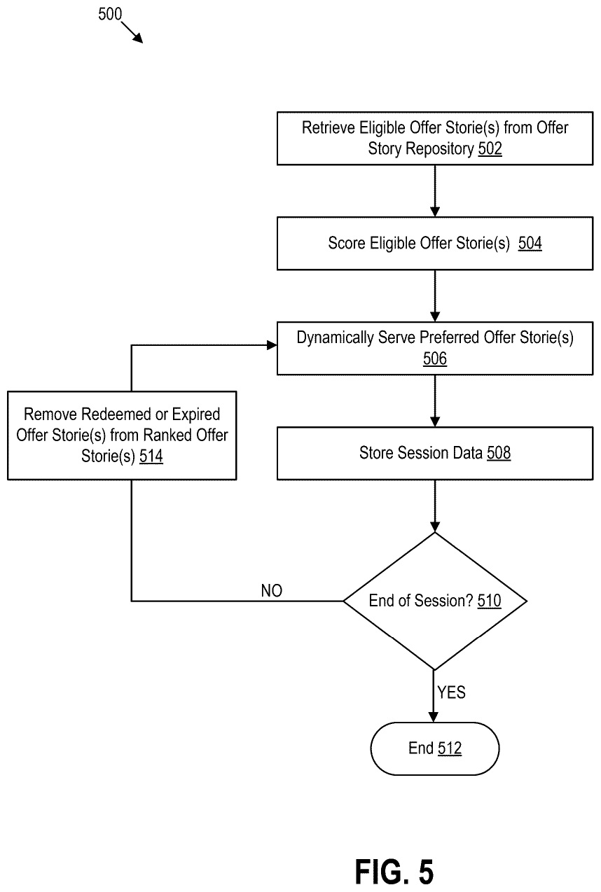

FIG. 5 is a flowchart of an example method 500. In some embodiments, operations of the method 500 may be performed by components of the content server system 112. In some embodiments, the content server system 112 may perform the method 500 to dynamically present eligible offer stories to a user device.

In the example shown, the content server system 112 may retrieve one or more eligible offer stories from the offer story repository (step 502). In some embodiments, the content server system 112 may retrieve a filtered subset of offer stories. An example of an eligible offer filter 202 is described above in connection with FIG. 2.

In the example shown, the content server system 112 may score the one or more eligible offer stories retrieved from the offer story repository (step 504). For example, the content server system 112 may score the one or more eligible offer stories to determine a ranked list of preferred offer stories. An example of scoring eligible offer stories is described above in connection with the offer scoring calculator 204 in FIG. 2.

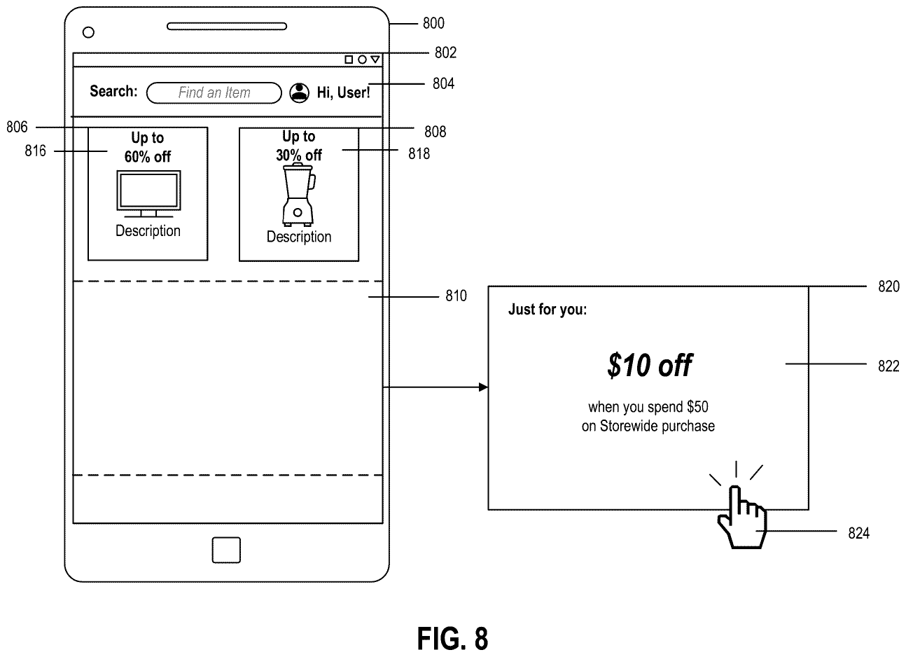

In the example shown, the content server system 112 may dynamically serve one or more preferred offer stories to an offer story container (step 506). For example, the content server system 112 may dynamically replace or collapse an offer story in response to a user interaction with an offer story. For example, the content server system 112 may dynamically replace a preferred offer story with the next highest ranked offer story in response to a user redeeming, refusing, or adding a preferred offer story to an offer library. Examples of step 506 will be further illustrated and described with reference to FIGS. 8-11.

In the example shown, the content server system 112 may store session data at the user database 114 or the offer story repository 115 (step 508). For example, session data may include updated user data that is automatically generated by user interaction with the user interface 316. In some embodiments, session data may include data indicating that an offer has been added, removed, or redeemed by a user. In some examples, session data may include a device sign-in status or a change in user credentials. Updated data can be used to further refine offer ranking to enhance personalization and contextualization of offer stories in an efficient and automated manner. Furthermore, updated data can be used to further enhance dynamic offer placement by automatically collapsing or replacing offer stories in response to feedback received at the user interface. Still further, updated data can be used to evaluate offer performance to further improve development, placement, and personalization of future offer stories.

In the example shown, the content server system 112 may determine whether a session is over (step 510). In response to determining that a session is over (e.g., taking the “YES” branch), the content server system 112 may end the method 500 (step 512). In response to determining that the session is not over (e.g., taking the “NO” branch), the content server system 112 may remove any redeemed, expired, or refused offer stories from the ranked list of offer storie(s) (step 514) and return to step 506. In some examples, the content server system 112 may remove offer stories from the ranked list if the redemption limit for the offer story has been reached or if the user has reached an offer redemption limit by redeeming one or more different offers. In some embodiments, the content server system 112 can then return to step 506 and dynamically serve the next highest ranked offer story to the same or different offer container at the user device. In some examples, if the content server system 112 has served a user with all of the eligible offer stories available to the user, then the content server system 112 can collapse the offer container or serve a generic offer story to the user.

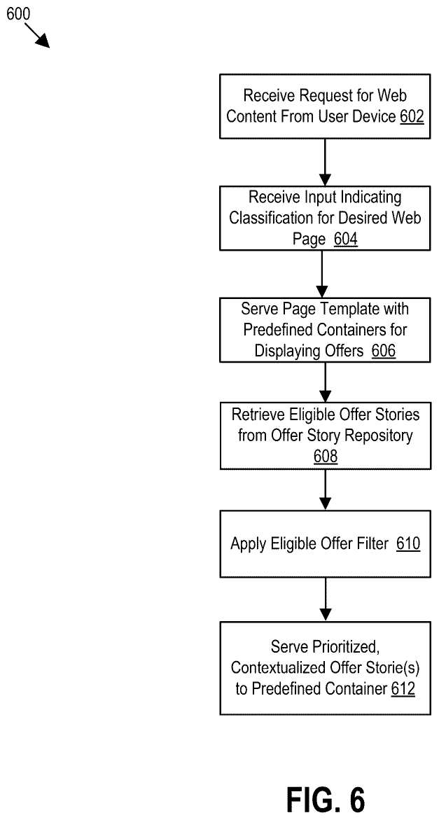

FIG. 6 is a flowchart of an example method 600. In some embodiments, operations of method 600 may be performed by components of the content server system 112. In some embodiments, the content server system 112 may perform method 600 to deliver contextualized offer stories to a user device.

In the example shown, the content server system 112 may receive a request for web content from a user device (step 602). For example, the content server system 112 may receive a request for web content by a user via a user interface. The request for web content may include a plurality of offer containers. In some examples, the plurality of offer containers may include offer containers on a home page. In other examples, the plurality of offer containers may include offer containers on a category page. In still other examples, the plurality of offer containers may include offer containers on an item page.

In the example shown, the content server system 112 may receive input indicating classification for desired web page (step 604). For example, a classification can indicate the web page that a user is currently viewing. In other examples, a classification can indicate a web page that a user has selected to view. In some embodiments, a classification can include a home page classification such that site wide offer stories are prioritized. In other embodiments, a classification can include a category classification such that category specific offers are prioritized such that a contextualized offer story is presented at the user device thus enhancing the user experience by conveniently presenting context appropriate offer stories based on the user's current interests.

In the example shown, the content server system 112 may serve a page template with predefined containers for displaying offers (step 606). The page template may be configured such that the eligible offer stories are placed predominantly within the web page. In some embodiments, the predefined containers can be dynamic such that they can be configured to be larger or smaller to accommodate different offer stories. In other embodiments, the predefined containers can be dynamic such that they can collapse in response to user interaction with the offer story or a change in offer eligibility status.

In the example shown, the content server system 112 may retrieve one or more eligible offer story from the offer story repository (step 608).

In the example shown, the content server system 112 may apply an eligible offer filter to the one or more eligible offer stories (610). In some implementations, the eligible offer filter may include a webpage context classification filter. An example of an eligible offer filter 202 is described above in connection with FIG. 2. An example of a webpage context classification engine 208 is described above in connection with FIG. 2.

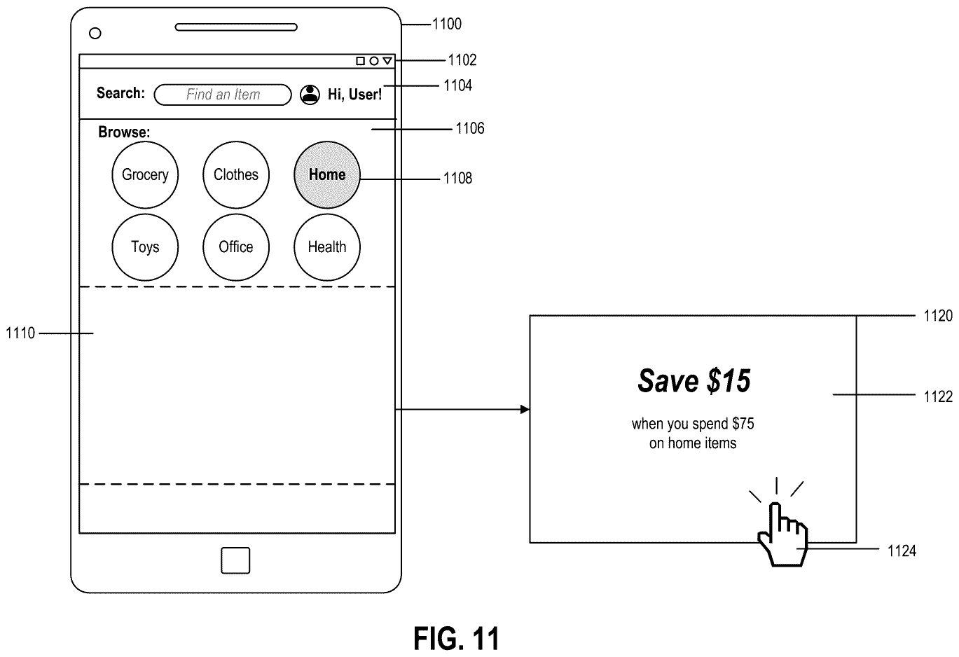

In the example shown, the content server system 112 may serve one or more prioritized, contextualized offer stories to the user device (step 612). An example of serving one or more contextualized offer stories is illustrated and described below in connection with FIG. 11.

As will be illustrated and described with respect to the example user interfaces shown in FIGS. 8-11, implementing the systems and methods described above provide significant technical advantages with respect to the ability to place dynamic offers in such a manner that provides a streamlined, flexible user experience in addition to efficient placement and replacement of relevant, context-appropriate offers. In particular, these user interfaces provide significant advantages over existing solutions which may present either non-personalized offers, offers for which a customer may not be eligible, or offers that have already been redeemed, any of which would lead to significant user frustration when interacting with a user interface.

FIG. 7 illustrates a user interface, according to an example embodiment. The example of FIG. 7 includes a computing device 700 displaying an example user interface 702. The user interface 702 includes example offer containers 706-712 that may be served by components described with respect to FIGS. 1-3.

The computing device 700 can be any device operable by a user to interact with network 108, as illustrated and described with respect to FIG. 1. The computing device 700 may be, for example, a mobile device, a tablet, a desktop device a smart watch, or another wired or wireless computing device with a user interface. For example, computing device 700 may display a user interface 702 to a user. For example, computing device 700 may be a device used by the user 102 such that the computing device 700 is not associated with user credentials. As such, a generic user interface will be displayed to the user.

As briefly described above, the example user interface 702 may be displayed on the computing device 700. In some examples, the user interface 702 may be an interface of a retail website that is associated with the enterprise information system 110. In other examples, the user interface 702 may be an interface of a mobile application that is associated with the enterprise information system 110. In the example shown, the user interface 702 includes a plurality of components including a header 704 and example offer containers 706-712.

The header 704 may include information related to a customer's sign-in status. As shown in the example illustrated in FIG. 7, the header 704 indicates that the user of computing device 700 is not signed in. As discussed with reference to the above examples, a customer's sign-in status can determine what user interface is displayed at the customer's computing device. In this example, because the user is not signed-in, a generic user interface will be displayed.

Offer containers 706-712 can be configured to display one or more offer stories. For example, offer containers 706-712 can be configured to display eligible offers or generic offers. In this example, in response to the computing device 700 not being associated with user credentials, the enterprise information system 110 may only deliver generic offers 716-722 to the offer containers 706-712 of the user interface 702. In the example illustrated in FIG. 7, offer containers 706-712 are shown displaying example generic offers 716-722, respectively. As will be discussed with reference to FIGS. 8-11, a change in the user's sign-in status can cause a different user interface to be displayed at the computing device in addition to enabling eligible offers to be served to the offer containers by the enterprise information system 110.

FIG. 8 illustrates a user interface, according to an example embodiment. The example of FIG. 8 includes a computing device 800 displaying an example user interface 802. For example, computing device 800 may display a user interface 802 to a user. For example, computing device 800 may be a device used by the user 104 or 106 such that the computing device 800 is associated with user credentials. In some embodiments, one or more components of the user interface 802 may be part of other user interfaces associated with the enterprise information system 110. Furthermore, the user interface may include more or fewer components than those illustrated in FIG. 8.

The computing device 800 can be any device operable by a user to interact with network 108, as illustrated and described with respect to FIG. 1. The computing device 800 may be, for example, a mobile device, a tablet, a desktop device a smart watch, or another wired or wireless computing device with a user interface. For example, computing device 800 may display a user interface 802 to a user. For example, computing device 800 may be a device used by the user 104 such that the computing device 800 is associated with user credentials. As such, a personalized user interface can be displayed on the computing device 800.

As described above, the example user interface 802 may be displayed on the computing device 800. In some examples, the user interface 802 may be an interface of a retail website that is associated with the enterprise information system 110. In other examples, the user interface 802 may be an interface of a mobile application that is associated with the enterprise information system 110. In the example shown, the user interface 802 includes a plurality of components including a header 804 and example offer containers 806-810.

The header 804 may include information related to a customer's sign-in status. In some embodiments, the header 804 may also include a search tool that may communicate with the enterprise information system 110. As shown in the example illustrated in FIG. 8, the header 804 indicates that the user of computing device 700 is signed in. In this example, because the user is signed-in, a personalized user interface can be displayed. Furthermore, because the suer is signed-in, eligible offers can be served to one or more of the offer containers 806, 808, and 810.

Offer containers 806, 808, and 810 can be configured to display one or more offer stories, respectively. In this example, in response to the computing device 800 being associated with user credentials, the enterprise information system 110 may serve a combination of eligible offers or generic offers to offer containers 806, 808, and 810. In this example, generic offers 816 and 818 are served to offer containers 806 and 808 of the user interface 802, respectively, and an eligible offer 820 is served to offer container 810.

In some implementations, one or more of offer containers 806, 808, and 810 can be configured to be dynamically adjusted in response to a change in eligibility or user interaction. For example, container 810 can be dynamically adjusted in response to a change in eligibility or user interaction with eligible offer 820. In some examples, container 810 can collapse in response to a change in eligibility. For example, a change in eligibility can include a change in an offer expiration event or a change in offer eligibility. For example, a change in offer eligibility can occur if a maximum number of eligible customers redeem an eligible offer. In other examples, a change in offer eligibility can occur if the user of device 800 has redeemed a maximum number of eligible offers, including or in addition to eligible offer 820. In some embodiments, container 810 can collapse in response to a change in user interaction with eligible offer 820. In some examples, user interaction with eligible offer 820 can include a user redeeming the eligible offer 820, e.g., by selection of the offer via a user selection operation 824 (e.g., clicking or tapping on the offer, thereby adding the offer to that user's digital account or cart). In other examples, user interaction with eligible offer 820 can include a user viewing but taking no action with respect to the eligible offer 820.

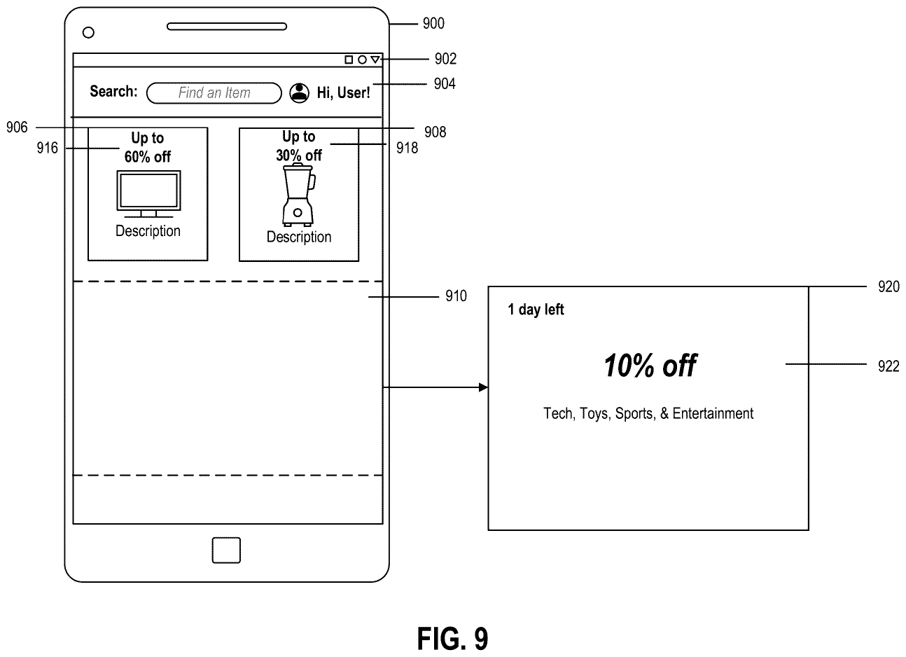

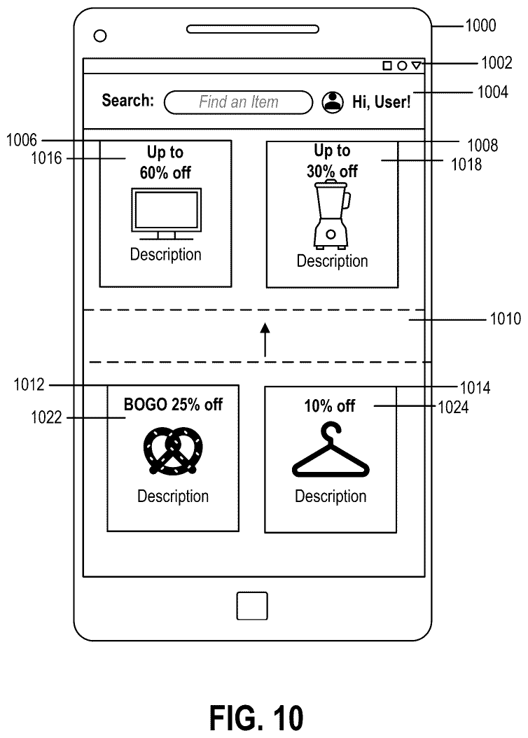

Eligible offer 820 is served to offer container 810. In some embodiments, eligible offer 820 can be a preferred offer story or the offer story assigned with the highest score by the content server system 112. In this example, eligible offer displays a storewide offer message 822. In some embodiments, eligible offer 820 can be interactive. For example, as illustrated in FIG. 8, a user 822 may interact with the eligible offer 920. For example, a user 822 may click on the eligible offer 920. In response to the user interaction, the user may be redirected to a dynamic promo listing page where the user may and redeem or accept the eligible offer 820. In some embodiments, after a user accepts the eligible offer, it may be automatically redeemed once the user makes an eligible purchase or a purchase on an eligible item for the eligible offer. In some embodiments, in response to user interaction with eligible offer 820, the eligible offer 820 can be applied to a purchase by the user. For example, eligible offer 820 can be applied a concurrent or subsequent purchase by the user. In some implementations, user interaction with the eligible offer 820 can cause a new offer to be displayed as will be illustrated and described with reference to FIG. 9. In other implementations, user interaction with the eligible offer 820 can cause the offer container 810 to collapse as will be illustrated and described with reference to FIG. 10.

FIG. 9 illustrates a user interface, according to an example embodiment. The example of FIG. 9 includes a computing device 900 displaying an example user interface 902. For example, computing device 900 may display a user interface 902 to a user. For example, computing device 900 may be associated with user credentials. In some embodiments, one or more components of the user interface 902 may be part of other user interfaces associated with the enterprise information system 110. Furthermore, the user interface may include more or fewer components than those illustrated in FIG. 9.

In some examples, the user interface 902 may be an interface of a retail website or mobile application that is associated with the enterprise information system 110. In the example shown, the user interface 902 includes a plurality of components including a header 904 and example offer containers 906, 908, and 910. The header 904 may include information related to a customer's sign-in status.

Eligible offer 920 is served to offer container 910. In some embodiments, eligible offer 920 can be a preferred offer story. In some embodiments, the eligible offer 920 can be the offer story assigned with the next-highest score by the content server system 112. For example, eligible offer 920 can be dynamically served to container 910 in response to replacing an offer story with a higher score that was redeemed or no longer eligible. In this example, eligible offer 920 displays a category specific offer message 922. Additionally, eligible offer 920 indicates that the offer has an expiration timeframe.

In some embodiments, eligible offer 920 can be interactive. In some embodiments, in response to user interaction with eligible offer 920, the eligible offer 920 can be applied to a concurrent or subsequent purchase by the user.

In some implementations, eligible offer 920 can by dynamically adjusted. For example, eligible offer 920 can be minimized in response to a user previously declining, previously accepting, or otherwise previously interacting with the offer. In other examples, eligible offer 920 can be dynamically adjusted in response to user interaction. In still other examples, eligible offer 920 can be dynamically adjusted in response to a change in eligibility status. For example, a change in eligibility status can include a change in a client eligibility score, maximum offer redemption criteria, or an offer expiration event. In some embodiments, the offer container 910 can collapse in response to a user interaction or a change in eligibility status as will be illustrated and described with reference to FIG. 10.

FIG. 10 illustrates a user interface, according to an example embodiment. The example of FIG. 10 includes a computing device 1000 displaying an example user interface 1002. For example, computing device 1000 may display a user interface 1002 to a user. For example, computing device 1000 may be associated with user credentials. In some embodiments, one or more components of the user interface 1002 may be part of other user interfaces associated with the enterprise information system 110. Furthermore, the user interface may include more or fewer components than those illustrated in FIG. 10.

In some examples, the user interface 1002 may be an interface of a retail website or mobile application that is associated with the enterprise information system 110. In the example shown, the user interface 1002 includes a plurality of components including a header 1004 and example offer containers 1006, 1008, 1010, 1012, and 1014. The header 1004 may include information related to a customer's sign-in status.

In some embodiments, offer containers 1006-1014 can be dynamic or static. For example, static offer containers cannot be dynamically adjusted. In some examples, dynamic offer containers can be adjusted or collapsed in response to user interaction or a change in eligibility. In other examples, dynamic offer containers can be adjusted to increase in size to emphasize an eligible offer. For example, a dynamic offer container can be increased in size to emphasize a highest ranking eligible offer. In other examples, dynamic offer containers can be adjusted to decrease in size to create space for additional eligible offers. In some embodiments, a dynamic offer story can be minimized or collapsed in response to user interaction or a change in eligibility. In the example shown, offer containers 1006, 1008, 1012, and 1014 may be static offer containers, while offer container 1010 may be a dynamic offer container.

In the example shown, offer container 1010 is being dynamically collapsed. For example, offer container 1010 may be collapsed in response to user interaction with an eligible offer as illustrated and described with respect to FIGS. 8 and 9. In other examples, offer container 1010 may be collapsed in response to a change in eligibility status. This provides a streamlined user interface and can provide room on the user interface 1002 for other offer stories.

In other embodiments, offer container 1010 can be dynamically adjusted to be bigger or smaller to accommodate offer stories of different sizes or to emphasize highly ranked offer stories. For example, offer container 1010 may be dynamically adjusted in response to a change in offer story size or offer story score. This provides a dynamic, personalized user interface that can emphasize offer stories with respect to user interest or high offer value.

FIG. 11 illustrates a user interface, according to an example embodiment. The example of FIG. 11 includes a computing device 1100 displaying an example user interface 1102. For example, computing device 1100 may display a user interface 1102 to a user. For example, computing device 1100 may be associated with user credentials. In some embodiments, one or more components of the user interface 1102 may be part of other user interfaces associated with the enterprise information system 110. Furthermore, the user interface may include more or fewer components than those illustrated in FIG. 11.

In some examples, the user interface 1102 may be an interface of a retail website or mobile application that is associated with the enterprise information system 110. In the example shown, the user interface 1102 includes a plurality of components including a header 1104, a category region 1106, and an offer container 1110. The header 1004 may include information related to a customer's sign-in status.

The category region 1106 may include one or more selectable categories or subcategories. In the example shown, the category region includes a selectable category for Grocery, Clothes, Home, Toys, Office, and Health. In some embodiments, the user interface 1102 may display one or more eligible offers in response to the user selecting one of the categories. As such, rather than serving generic offers or eligible offers at random, a dynamic and contextualized user experience may be provided.

Home Category 1108 is selected in the example illustrated in FIG. 11. Responsive to Home Category 1108 being selected, eligible offer 1120 is served to offer container 1110. In some embodiments, eligible offer 1120 can be a subset of category offers identified at the webpage context classification engine 208 illustrated and described with respect FIG. 2.

In this example, in response to the user selecting Home Category 1108, eligible offer 1120 displays a contextualized, home items offer message 1122. As further illustrated in FIG. 11, eligible offer 1120 can be selected (e.g., clicked on) by a user 1124. For example, a user can select the eligible offer 1120 to redeem the offer. In some implementations, in response to a user interaction, the user can be redirected to a dynamic promo listing page where the user can select a button to apply the offer. Once the user makes a purchase on an eligible item for the offer, the offer may be automatically redeemed. By placing relevant, context-appropriate offers, user interface 1102 provides a streamlined, personalized user interface and is an advantage over existing solutions.

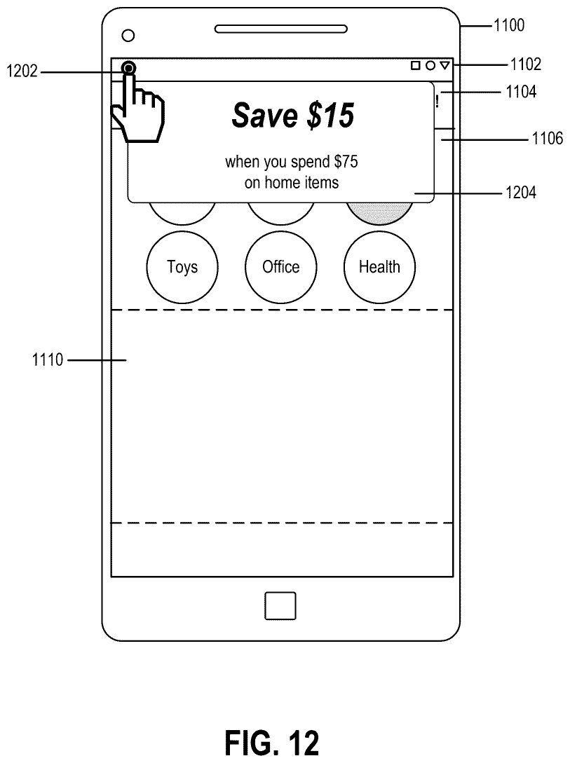

FIG. 12 illustrates a push notification user interface 1200, according to an example embodiment. The example of FIG. 12 includes a computing device 1100 displaying a push notification interface 1202. In some embodiments, eligible offer stories may be delivered as push notifications to client computing devices as an alternative or supplement to web-based display within offer containers.

The system performs eligibility verification through user eligibility calibrator 200 and user eligibility data service 220 before sending push notifications, ensuring only qualified users receive notifications for eligibility-restricted offers. This prevents user frustration from receiving notifications for offers they cannot redeem. In the example shown, push notification 1202 displays an eligible offer message 1204 promoting a home items offer (“Save $15 when you spend $75 on home items”). The push notification includes the same offer content that may be displayed in web-based offer containers, demonstrating the unified content pool architecture where single-instance offer stories are adapted for multiple delivery channels.

In some implementations, the decision to send a push notification for a particular eligible offer is based on the same scoring and filtering processes described with respect to FIGS. 2-3, in which the eligible offer scoring calculator 204 ranks offers and the eligible offer filter 202 verifies eligibility before the offer story server 210 formats and delivers the notification through a push notification service. Push notifications may be triggered based on user behavior, time-based campaigns, or real-time eligibility status changes detected by the user eligibility data service 220.

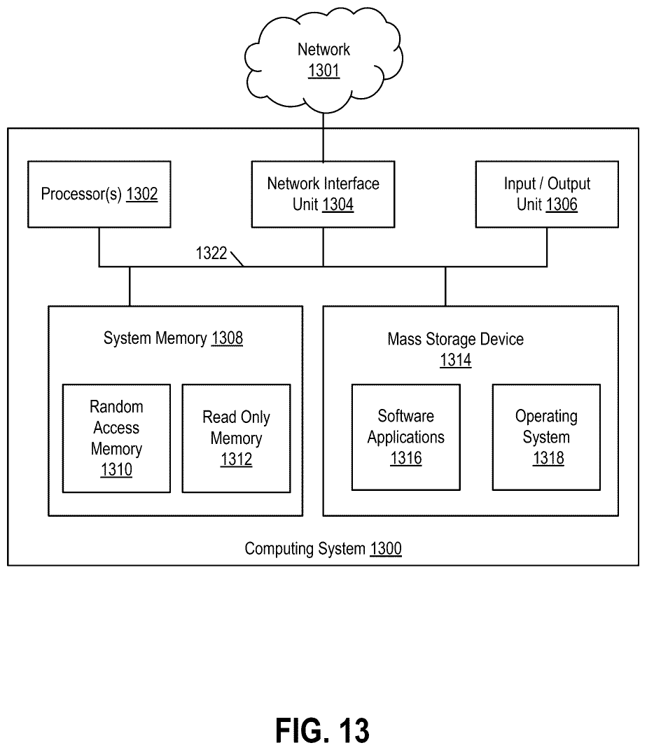

FIG. 13 illustrates an example block diagram of a virtual or physical computing system 1300. One or more aspects of the computing system 1300 can be used to implement the systems described herein, store instructions described herein, and perform operations described herein.

In the embodiment shown, the computing system 1300 includes one or more processors 1302, a system memory 1308, and a system bus 1322 that couples the system memory 1308 to the one or more processors 1302. The system memory 1308 includes RAM (Random Access Memory) 1310 and ROM (Read-Only Memory) 1312. A basic input/output system that contains the basic routines that help to transfer information between elements within the computing system 1300, such as during startup, is stored in the ROM 1312. The computing system 1300 further includes a mass storage device 1314. The mass storage device 1314 is able to store software instructions and data. The one or more processors 1302 can be one or more central processing units or other processors.

The mass storage device 1314 is connected to the one or more processors 1302 through a mass storage controller (not shown) connected to the system bus 1322. The mass storage device 1314 and its associated computer-readable data storage media provide non-volatile, non-transitory storage for the computing system 1300. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1300.

According to various embodiments of the invention, the computing system 1300 may operate in a networked environment using logical connections to remote network devices through the network 1301. The network 1301 is a computer network, such as an enterprise intranet and/or the Internet. The network 1301 can include a LAN, a Wide Area Network (WAN), the Internet, wireless transmission mediums, wired transmission mediums, other networks, and combinations thereof. The computing system 1300 may connect to the network 1301 through a network interface unit 1304 connected to the system bus 1322. It should be appreciated that the network interface unit 1304 may also be utilized to connect to other types of networks and remote computing systems. The computing system 1300 also includes an input/output controller 1306 for receiving and processing input from a number of other devices, including a touch user interface display screen, or another type of input device. Similarly, the input/output controller 1306 may provide output to a touch user interface display screen or other type of output device.

As mentioned briefly above, the mass storage device 1314 and the RAM 1310 of the computing system 1300 can store software instructions and data. The software instructions include an operating system 1318 suitable for controlling the operation of the computing system 1300. The mass storage device 1314 and/or the RAM 1310 also store software instructions, that when executed by the one or more processors 1302, cause one or more of the systems, devices, or components described herein to provide functionality described herein. For example, the mass storage device 1314 and/or the RAM 1310 can store software instructions that, when executed by the one or more processors 1302, cause the computing system 1300 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A webserver system for dynamically serving offer stories, the system comprising:
a data repository configured to store a plurality of offer stories;
a server system in data communication with the data repository and a plurality of client computing devices, wherein the server system is configured to:
receive a request for web content from a client computing device of the plurality of client computing devices, wherein the client computing device is associated with user credentials;
retrieve a plurality of offer stories from the data repository;
score the plurality of offer stories based on one or more predetermined variables to generate a ranked list of offer stories;
assign an eligibility score to the client computing device based on user eligibility data associated with the user credentials;
determine, at serve time and based on the eligibility score, a subset of eligible offer stories from the ranked list of offer stories;
select one or more preferred offer stories from the subset of eligible offer stories based on ranking; and
serve the one or more preferred offer stories to the client computing device within a container of the web content designated for display of offer stories.

2. The webserver system of claim 1, wherein selection of the one or more preferred offer stories is dynamically adjusted in response to a change in eligibility or user interaction with the one or more preferred offer stories.

3. The webserver system of claim 2, wherein dynamically adjusting selection or display comprises resizing the container to emphasize a highest-ranked offer story.

4. The webserver system of claim 2, wherein the change in eligibility includes an offer expiration status associated with at least one of the offer stories.

5. The webserver system of claim 1, wherein the one or more predetermined variables used to score the plurality of offer stories include an offer redemption criterion.

6. The webserver system of claim 1, wherein assigning the eligibility score to the client computing device comprises retrieving, from a loyalty service, real-time eligibility data for one or more segmented offers.

7. The webserver system of claim 6, wherein retrieving the subset of offer stories based on the eligibility score includes determining a current eligibility status for each of a plurality of offer stories, comparing user interaction history to eligibility criteria for each of the plurality of offer stories, and assessing an offer redemption status for each of the plurality of offer stories.

8. The webserver system of claim 6, wherein serving the one or more preferred offer stories includes dynamically updating visibility of one or more offer stories based on at least one of a change in eligibility of a user, an offer redemption history of the user, or an expiration status of the one or more offer stories.

9. The webserver system of claim 1, wherein scoring is performed after eligibility filtering.

10. The webserver system of claim 1, wherein the server system assigns an allocation status to an offer story when the offer story is served to the client computing device, the allocation status reserving the offer story for the user prior to redemption.

11. The webserver system of claim 10, wherein the allocation status expires automatically upon expiration of a browsing session or a predetermined time period.

12. The webserver system of claim 1, wherein scoring the plurality of offer stories comprises applying a machine-learning model trained on historical user interaction data, and wherein the machine-learning model comprises a collaborative filtering model or a gradient-boosting model.

13. The webserver system of claim 1, wherein the data repository stores each offer story as a single-instance content object configured for presentation across a plurality of delivery channels.

14. The webserver system of claim 1, wherein serving the one or more preferred offer stories comprises delivering the offer story as a push notification to the client computing device.

15. A method of dynamically serving offer stories, the method comprising:
receiving a request for web content from a client computing device, wherein the client computing device is associated with user credentials;
retrieving a plurality of offer stories from an offer story repository;
scoring the plurality of offer stories based on one or more predetermined variables to generate a ranked list of offer stories;
assigning an eligibility score to the client computing device based on user eligibility data associated with the user credentials;
determining, at serve time and based on the eligibility score, a subset of eligible offer stories from the ranked list of offer stories;
selecting a highest-ranked offer story from the subset of eligible offer stories; and
serving the highest-ranked offer story to the client computing device within a container of the web content designated for display of offer stories.

16. The method of claim 15, wherein dynamically adjusting the highest-ranked offer story comprises collapsing the container in response to a user interaction with the highest-ranked offer story.

17. The method of claim 15, wherein dynamically adjusting the highest-ranked offer story includes automatically replacing the highest-ranked offer story with a next highest ranked offer story.

18. The method of claim 15, wherein the one or more predetermined variables used to score the plurality of offer stories include identifying whether an offer story is a storewide offer or a segmented offer.

19. A webserver system for dynamically serving offer stories, the system comprising:
a data repository configured to store a plurality of offer stories;
a server system in data communication with the data repository and a plurality of client computing devices, wherein the server system is configured to:
receive requests for web content from the plurality of client computing devices, wherein a subset of the client computing devices are associated user credentials;
identify a subset of category offers at a webpage context classification engine;
assign a client eligibility score to the client computing devices associated with user credentials;
retrieve, based the client eligibility score, a subset of offer stories from the data repository;
score the subset of offer stories based on one or more predetermined variables to obtain one or more preferred offer story; and
serve the one or more preferred offer stories to the client computing devices associated with user credentials within a container within the web content designated for display of offer stories.

20. The webserver system of claim 19, wherein:
the server system is further configured to filter a subset of offer stories based on one or more of: an offer expiration status, an offer allocation status, an offer added status, or an offer redemption criterion, and
offer redemption criterion includes at least one of an offer redeemed status or an offer redemption limit status.
